(19) United States
(12) Patent Application Publication
(10) Pub. No.: US 2008/0288349 A1
(43) Pub. Date: Nov. 20, 2008

(54) METHODS AND SYSTEMS FOR ONLINE INTERACTIVE COMMUNICATION

(76) Inventors: Jonathan S. Weisberg, Santa Barbara, CA (US); Michael McCarthy, Simi Valley, CA (US); Donna Cohen, Sherman Oaks, CA (US); Jim Van Baalen, Santee, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/035,383

(22) Filed: Feb. 21, 2008

Related U.S. Application Data
(60) Provisional application No. 60/891,202, filed on Feb. 22, 2007.

(51) Int. Cl. G06Q 30/00; G06F 3/048; G06F 15/16

(52) U.S. Cl. 705/14; 715/753

(57) ABSTRACT

Systems and methods of providing interactive online communication are described. A chat enabled communication is transmitted over a network to a user via a browser hosted on a user terminal, wherein the communication is provided to the user in association with search results at least partly in response to a search query from the user, and wherein the communication includes a chat control. A connection is made between a chat server and a chat interface associated with the communication, wherein the chat interface including a text entry and display area, and wherein the connection is made after the user has activated the chat control and/or taken an action that satisfies a first chat connection rule. A chat agent is then connected to the chat interface in order to participate in a chat session.

### CROSS-REFERENCE TO RELATED APPLICATIONS

The present application claims priority from U.S. Patent Application No. 60/891,202, filed Feb. 22, 2007, the content of which is incorporated herein in its entirety.

### STATEMENT REGARDING FEDERALLY SPONSORED R&D

Not applicable.

### PARTIES OF JOINT RESEARCH AGREEMENT

Not applicable.

### REFERENCE TO SEQUENCE LISTING, TABLE, OR COMPUTER PROGRAM LISTING

Not applicable.

### BACKGROUND OF THE INVENTION

1. Field of the Invention

The present invention is related to telecommunications, and in particular to methods and systems for initiating communications via a data network.

2. Description of the Related Art

Online chat has been increasingly used to enable website agents to communicate with website visitors. For example, online chat is sometimes used to help a visitor complete a purchase or to identify a product in which they are interested.

However, conventionally, in order for a visitor to access online chat services, the visitor has to locate a website offering a good or service the visitor is interested in, then the visitor has to navigate to the website, and once on the website, navigate to one or more pages in order to access chat services.

### SUMMARY OF THE INVENTION

Example methods and systems are described herein that provide online interactive communication via a webpage. The online interactive communication may be provided in the form of online chat. Certain embodiments enable chat interaction much earlier in user's decision cycle (e.g., with respect to item purchases) as compared to conventional system and therefore enable selection of potential consumers from a much larger audience.

In an example embodiment, an advertisement (e.g., for a product or service) is transmitted to a user browser. The advertisement includes a chat user interface via which the user can chat with an agent regarding the subject of the advertisement or to ask for related help. Thus, the advertisement is a method for providing enhanced services to the user while at the same time providing a more effective vehicle for the advertiser to facilitate the achievement of the advertiser's goals (e.g., the sale of products or services, the viewing of information, etc.).

Elements of a given embodiment described herein can include or be combined with elements of other embodiments described herein.

An example embodiment provides a method of providing interactive online communication, the method comprising: causing at least in part a chat enabled advertisement to be provided over a network to a user via a browser hosted on a user terminal, wherein the advertisement is provided to the user at least partly in response to a search query from the user, and wherein the advertisement includes information regarding a product or service and includes a chat control; causing at least in part a connection to be made between a chat server and a chat interface associated with the advertisement, the chat interface including a text entry and display area, wherein the connection is made after the user has activated the chat control and/or taken an action that satisfies a first chat connection rule; and at least partly enabling a human chat agent to chat at least textually with the user.

An example embodiment provides a method of providing interactive online communication, the method comprising: causing at least in part an advertisement to be provided over a network to a user via a browser hosted on a user terminal, wherein the advertisement includes a chat interface, and wherein the advertisement includes information regarding a product or service and includes a chat control; causing at least in part a connection to be made between a chat server and the chat interface associated with the advertisement, the chat interface including a text entry and display area; and at least partly to the occurrence of a first condition, enabling a human chat agent to chat at least textually with the user via the advertisement chat interface.

An example embodiment provides a system configured to provide interactive online communication, the system comprising: a first data store that stores a chat enabled advertisement; a first computer system coupled to the first data store, the first computer system configured to serve the chat enabled advertisement; and a chat system configured to conduct an online chat via the chat enabled advertisement.

An example embodiment provides a method of providing interactive online communication, the method comprising: causing at least in part an advertisement for a first item to be provided over a network to a user via a browser hosted on a user terminal; if a first condition is met, at least partly causing the advertisement to be displayed via the browser with an associated chat interface; and if a first condition is not met, at least partly causing the advertisement to be displayed via the browser without an associated chat interface.

### BRIEF DESCRIPTION OF THE DRAWINGS

Illustrative embodiments will be described with reference to the drawings summarized below. These drawings and the associated description are provided to illustrate example embodiments, and not to limit the scope of the invention.

FIG. 1 illustrates an example system architecture.

FIG. 2 illustrates an example chat process.

### DETAILED DESCRIPTION OF PREFERRED EMBODIMENTS

Example methods and systems provide online interactive communication via online advertisements. The online advertisements may be targeted towards a selected audience to enable the targeted audience to engage in a live chat (e.g., regarding the subject of the advertisement or otherwise). The live chat may be used to answer a user's questions, to help the user complete forms or place an order, or to facilitate the accomplishment of one or more other campaign goals.

Thus, certain embodiments are optionally used to complement traditional online advertising campaigns by embedding live chat within a display mechanism of the campaign (e.g., an advertisement, such as a banner advertisement). By way of illustration, one or more advertisements can be utilized to attract traffic to a website associated with the advertisement or used within a website to facilitate the accomplishment of one or more goals. The chat enabled advertisements and associated chat sessions can include text, sound, graphics, animation, VoIP, video conferencing, click to call and/or movie clips. Certain embodiments address the technical challenge of reducing the number of steps a user needs to take in order to obtain live help regarding a product or service advertised on a third party web page. Certain embodiments address the technical challenge of determining when an advertisement should be configured as a static advertisement (with a chat user interface being displayed) and when an advertisement should be configured as a chat enabled advertisement. Certain embodiments address the technical challenge of determining when a chat enabled advertisement chat interface should be connected to a chat service.

A chat service may be provided as a one-on-one text-based chat or text-based group chat. In an example embodiment, a chat client (e.g., embedded in a web page displayed via a browser on a user terminal) provides a user interface including an input area in which a user can type in a message (e.g., a request for help or information). The message is transmitted to an agent (e.g., a person who acts on behalf of the website operator to promote one or more goals associated with the website, such as an online sales person) in substantially real time or after the user activates a send/transmit control. The agent can then respond to the user (e.g., to the user's request for help or information), where the response will be displayed to the user in substantially real time (or after the agent activates a send/transmit control) via the chat client.

Thus, an example chat service provides a user with the ability to at least textually chat (e.g., with a customer service representative/agent). By way of example and not limitation, the chat client can be implemented using Adobe Flash technology, HTML, Java applets, and/or other technologies.

In discussing example embodiments, the term “Website” is used to refer to a user-accessible server site that implements the basic World Wide Web standards for the coding and transmission of hypertextual documents. These standards currently include HTML (the Hypertext Markup Language) and HTTP (the Hypertext Transfer Protocol). It should be understood that the term “site” is not intended to imply a single geographic location, as a Web or other network site can, for example, include multiple geographically-distributed computer systems that are appropriately linked together. Furthermore, while the following description relates to an embodiment utilizing the Internet and related protocols, other networks, such as networked interactive televisions, and other protocols may be used as well.

In addition, unless otherwise indicated, functions described herein are preferably performed by software including executable code/program instructions running on one or more computers. The computers can include one or more central processing units (CPUs) that execute program code and process data, memory, optionally including volatile memory, such as random access memory (RAM) for temporarily storing data and data structures during program execution, non-volatile memory, such as a hard disc drive, optical drive, or FLASH drive (e.g., for storing programs and data, including databases, which may be referred to as a “system database,”) and a network interface for accessing an intranet and/or Internet. In addition, the computers can include a display via which user interfaces, data, and the like can be displayed, and one or more user input devices, such as a keyboard, mouse, pointing device, microphone and/or the like, used to navigate, provide commands, enter information, provide search queries, and/or the like.

However, the present invention can also be implemented using special purpose computers, terminals, state machines, and/or hardwired electronic circuits. In addition, the example processes described herein do not necessarily have to be performed in the described sequence, and not all states have to be reached or performed. While personal computers or laptops may be referenced herein, other terminal types can be used as well, such as interactive televisions, phones, etc.

In addition, while reference may be made to certain programming languages, such as JavaScript (a scripting language that may be executed by a client side application, such as a web browser), other types of programming languages may be used as well (e.g., VBScript, AJAX (Asynchronous JavaScript and XML), etc.).

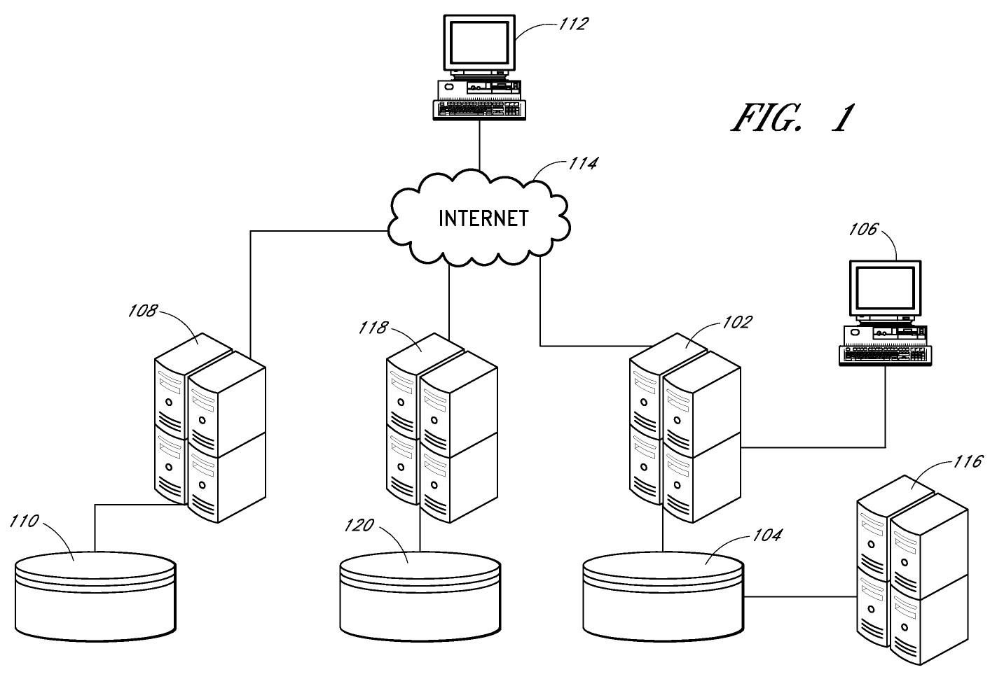

FIG. 1 illustrates an example configuration including:

an ad bearing website 108;

a chat system including one or more chat servers 102, agent terminals 106, and a chat database 104;

one or more visitor applications, such as a browser 112, that can be used to access and/or provide information over a network (e.g., hosted on one or more terminals, such as a personal computer, interactive television, phone, etc.);

The chat system 102 can include network interfaces (e.g., data interfaces to the Internet 114) used to communicate with the ad bearing website 108, the visitor browser 112, and/or the advertisement media server 118. Optionally, the chat system 102 can access information (e.g., information regarding a website visitor, such as demographic and purchase history information) stored in the ad bearing website database 110. The chat system 102 optionally also includes an administration server 116 coupled to the database 104. The administration server 116 can be utilized to configure an advertisement and chat for a given advertiser. In addition, the administration server 116 stores configurations for a given ad to associate the ad to the specifics of a program/campaign (e.g., associated with customers of the chat service provider that operates the chat system 102), such as the identity of the advertiser/client of the chat service, and/or the product/service associated with the ad.

The chat service may be provided by the chat system 102 using instant messaging applications. By way of example and not limitation, the chat service can be provided using Internet Relay Chat, MUCKs, MUSHes and MOOes, or other technology.

The ad bearing website 108 can offer products and/or services via an online catalog. By way of further example, the ad bearing website 108 can be a search website (e.g., configured to support rich media) that displays search results and advertisements related to the search results (e.g., based on key words specified by the advertiser and that are used in the search terms and/or that appear in the search results). The ad bearing website 108 can include one or more Web servers (that accepts HTTP requests from clients, such as web browsers, and serves HTTP responses in addition to optional data contents, such web pages (e.g., HTML documents and linked objects, such as images), and that receive user inputs), databases 110, and interfaces (e.g., data interfaces to the Internet) used to communicate with the chat system 102 and the visitor browser 112.

By way of example, the chat server 102 is optionally implemented as a socket-based server (e.g., coded using Java, Perl, C++, and/or other language) which controls communication between the chat client used by an end user and an agent, where the agent uses a terminal 106 to interact with the end user. The agent terminal can be, by way of example, a computer running a web browser, and can be the same type as, or a different type than the visitor terminal. By way of further example, the chat server can be implemented using other client server protocols such as JMS (Java Message Service), MQ, etc.

The chat service provided via the chat servers 102 receives, acts on, and/or collects data regarding visitors. The chat server 102 may utilize an operating system such as Unix, Linux, Solaris, a Windows-based operating system, an OS X based operating system, or other operating system. The chat service can receive information from and/or provide information to the ad bearing website 108. The chat service optionally determines when to launch a chat, performs a chat launch accordingly, connects a site visitor who has interacted with a chat client to an agent and/or records site conversions.

Optionally, the chat service provides a visitor with a context-sensitive first interaction that appears to originate from a human chat agent but actually is automatically provided by the chat service (e.g., an initial automated chat greeting, such as “Hello, can I help you or answer any questions?”). In such an embodiment, when and if the visitor responds to the initial chat communication from the chat service, the visitor is then “connected to” a human chat agent (if one is available) for further chat interaction.

The chat database 104 (e.g., a MYSQL, Oracle, Sybase, MSSQL, or other type of database) can store statistical information which is collected about a given chat, optionally including, where and how the chat was launched, the time between when the chat was displayed until the visitor's first interaction, the duration of the chat, the chat transcript and so forth.

By way of further illustration, the chat database 104 can store some or all of the following information and/or different information, which may be obtained via a chat beacon, chat cookie, other tracking mechanism, another database, or otherwise:
a unique identifier associated with a given visitor;
a unique identifier associated with the visitor's browser;
referring information, including some or all of the following:
   referring domain (e.g., the domain of the website that the user visited just before they accessed the ad bearing website 108, where, for example, the referring domain is an advertising partner or a web page with a link to the ad bearing website 108, wherein the user activated the link to access the website 108);
   referring keyword (e.g., a keyword used by the visitor leading to the chat enabled site via an Internet search engine or directory);
   campaign data (e.g., indicating which advertising campaign or program referred the visitor to the ad bearing website 108);
website behavior, such as visitor navigation information on the ad bearing website 108, including some or all of the following:
   number of visits to the ad bearing website 108;
   time spent on the website 108;
   content interest (e.g., as measured by time spent on a given website page having certain content, search terms used, number of returning visits to a given page, etc.);
the Internet Service Provider associated with the visitor;
demographic information (e.g., generated based on IP address or provided by the ad bearing website database based on prior knowledge of the visitor) including, but not limited to some or all of the following:
   location of the visitor (e.g., country, state, city);
   language of the visitor;
   gender of visitor (which may be obtained directly from the visitor via a form or may be obtained from a user account database associated with the website);
   age of visitor;
   income of visitor;
website specific visitor interaction data (e.g., data a visitor provides via forms and/or other applications on a website that may be indicative of their interests).

Some or all of the foregoing data can be reported to an authorized recipient, who can use the information to evaluate the performance of a marketing campaign, chat effectiveness, etc.

For example, the chat cookie can be used to enable the live chat application to persist information about a visitor (e.g., in order to group individual actions of the visitor to thereby facilitate understanding of the visitor's online behavior).

The advertisement media server 118 stores advertisements in database 120 and delivers them to website visitors, such as those to the ad bearing website 108. The advertisements can be in the form of chat-enabled ads and/or non-chat enabled ads. By way of example, a chat enabled advertisement can be in the form of a rich media, such as a Flash movie. By way of further example and not limitation, display ads containing online interactive communication technology can be implemented as a system of Java, HTML, Flash movies, Quicktime movies and/or JavaScript conducted across HTTP requests from a user's browser to one or more chat servers. The advertisement media server 118 and database 120 can be co-located with the website server 108 and/or chat server 102 and operated by the same entity, or can be operated by a third party at another location. The various components can communicate with each other via the Internet 114 and/or other networks.

The chat server 102 can perform some or all of the following processes:
upload advertisements based on one or more rules;
target ads to different users based on user characteristics/behavior and/or based on the content being accessed or viewed;
limit the number of times an ad is presented to a given user;
sequence different ads presented to a user in a specific order;
detect and report on the number of viewings/impressions, clicks, post-impression activities, post-click activities, and interactions;
etc.

In an example embodiment, program code (e.g., in the form of JavaScript, Macromedia Flash, etc.) is embedded in an advertisement presented on a web page (e.g., a web page associated with an online merchant, a web page associated with a search engine via which the user can conduct searches for information, products and/or services, etc.) accessed by a user. For example, the program code may be utilized to write functions that are embedded in or included from HTML pages and interact with the Document Object Model (DOM) of the browser. By way of illustration, program code can be embedded in an ad to establish communication, determine the availability of agents, set the state of banner, launch a chat, etc.

In an example scenario, discussed with reference to the figures below, a request for a chat enabled advertisement/banner is embedded in a third party webpage. The banner returned from that request has chat program code embedded. Optionally, before a chat can begin, a request is made to the chat service system to determine the availability of agents that can chat with the user. Based on the response the banner advertisement will or will not be enabled for chat when it is displayed on the third party website. Assuming that an agent is available, a chat session is initiated and the chat user interface is displayed. With the user's permission, the agent pushes the user to a persistent chat session. The agent then pushes the user to the client (of the chat service) website and guides them through a website visit (e.g., guiding the user through a purchase process). If an agent is not available, a chat session is not initiated and optionally the banner will be configured so that a chat interface is not displayed to the user.

In an example embodiment, the chat enabled ad calls the chat system 102 (e.g., a chat server) to initiate a chat.

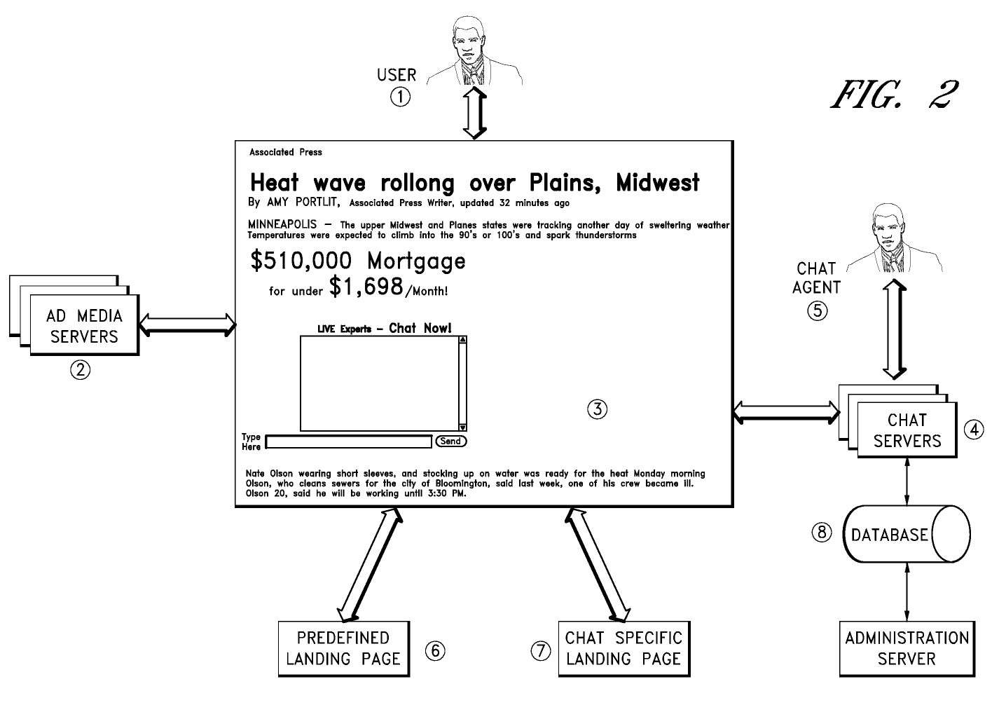

Referring now to FIG. 2, an example process is described. The process includes series of interactions between a website which deploys advertising media, a chat enabled website, a user's web browser, and servers used to deploy chat (e.g., using HTTP and/or other protocols).

At state 1, a user operating a browser equipped terminal (such as terminal 112) visits a web page that contains an advertisement with online interactive communication technology, such as that described herein. For example, while browsing the Internet or conducting an online search, a user may encounter a page hosted by website 108 that contains an online interactive communication mechanism in the form of a chat advertisement. By way of illustration, a chat integrated ad can be provided on one or more locations, such as a website webpage (e.g., on the website to which the advertisement is leading the visitor, such as via a link), a popup generated from the website, a third party website, a popup generated from a third party website, a web enabled application capable of displaying display ads rendered using one or more web technologies (e.g., media players, flash applications, RSS readers, emails, such as HTML emails, or elsewhere).

At state 2, as the web page loads, a request is made to load the media for the online interactive communication advertisement. By way of example, the media file can be loaded directly from the chat servers (e.g., chat servers associated with chat system 102), from a static content server, from an advertisement media server 118 associated with a third party ad serving vendor, the website 108 being visited, or other source. Optionally, the ad media can be in the form of rich media (e.g., that exhibits or is capable of exhibiting dynamic motion, playing audio tracks, etc.) such as, by way of example, a Macromedia Flash movie or JavaScript containing graphics. Optionally, if certain conditions are met (e.g., an agent is available), the ad will be configured so that a chat interface is displayed. Otherwise, the ad will be configured so that it is static (a chat interface is not displayed). The advertisement can be purely text based, or can include text, images, and/or motion (movies, animations, etc.).

The chat enabled ad can have more than one behavior. For example, the ad behavior may change or be selected based in whole or in part on attributes and/or behavior of a visitor (which may be indicative of their proclivity to take a desired action, such as make a purchase, fill out a form, access information, etc.), availability of agent to engage in chat with the visitor, a desired visitor experience, etc. The following provide non-limiting examples of chat behavior.
the ad enables the user to engage a chat agent;
the ad acts as a link to an appropriate location, such as a page of a website providing services/products being advertised;
the ad is a hybrid in that clicking on in a text input area enables the user to engage a chat agent but clicking elsewhere or in certain other locations in the ad directs the browser to an appropriate location, such as a page of a website providing services/products being advertised; or
other behaviors

At state 3, the media and associated chat code is executed on the visitor's web browser, which loads a chat window. To accomplish this, a request (e.g., an HTTP request) is made to the advertisement media server 118 to load the online interactive communication (e.g., chat enabled) media and display it in the user's browser. The online interactive communication advertisement can contain one or more types of media, such as text, movie clips, audio clips, animation and so forth. The online interactive communication advertisement may include chat features, such as a transcript window pane (containing the chat conversation), a text entry box (which enables the consumer to type a message to the agent), and a “send” button or other control (which enables the user to send messages to the agent). In the illustrated example, the web page includes an ad with an associated chat interface presented in association with a news article,

When the chat enabled advertisement is displayed, it can begin displaying predetermined, “bot” generated chat (a program that replaces or precedes the agent and that generates chat lines based on known attributes of the user, user chat lines, the goals of the client website, etc.) or agent generated chat lines (e.g., inviting the consumer to interact with the agent via a chat session).

At state 4, when the consumer attempts to interact with the chat, a connection is established to the chat servers. Optionally, in order to avoid an incoming connection for each chat interface that is displayed in an advertisement, a connection is not made to the chat server or live agent until the user interacts with the chat in a way that satisfies a chat launch rule (e.g., that indicates that the user is interested in conversing an agent or may need help). “Chat” text may appear in the ad, giving the impression that a connection to an agent has already occurred, but this may be pre-scripted chat text, where the agent is not connected until the user has taken a certain action (e.g., sent text via the chat interface). Once activated, the chat media may initiate a connection to the chat server over a socket, HTTP, or using another connection protocol. Optionally, a connection is made to the chat server prior to the user indicating interest in a chat session (e.g., making a connection when the chat interface is displayed). Optionally, every displayed advertisement is connected to a server and optionally to a human agent.

At state 5, when a connection has been established, the chat session is routed (e.g., by chat system 102) to an agent (e.g., a live agent) who can engage in a chat with the user. In addition, related information can be presented to the agent (e.g., via agent terminal 106). For example, the related information can include information regarding where this chat originated (e.g., via which website), what search terms where used by the user in causing the ad to be presented, message(s) typed in by the consumer to a live agent, the geographical region of the user, etc. The user and agent are then able to have a conversation (e.g., a text and/or multimedia conversation).

Optionally, the agent moves the consumer into a persistent environment, wherein the chat interface remains displayed even while the agent navigates the user to different web pages and/or multimedia content (e.g., to help the user, to discuss or recommend products or services to the user, to take a user order, etc.), as at state 7. For example, the chat user interface can be presented via a frame, such as an inline frame (iFrame) or using an xFrame. An iFrame is an HTML element which makes it possible to embed another HTML document (e.g., accessed using a tag, including a URL (Universal Resource Locator)) inside the main document (e.g., within the HTML of the actual client page). The contents of the frames may be hosted on the same server as the parent/main page, or a frame may link in code from another website server, wherein the remote content is loaded and automatically displayed within the frame. An xFrame is an XML application for combining multiple documents together. By way of further example, the chat interface can be presented with the appearance of a pop-up window or as inline user interface.

The chat will proceed until it is terminated (e.g., by the user or the agent).

In certain instances, rather than being directly provided with a chat session via an ad, the user may click on the ad (with a link to the advertiser's website or other location) and the browser will be directed to the corresponding website (e.g., at state 6, to a predefined landing page). This may occur as a result of the user choosing to click the ad without engaging in a chat even though chat is available (e.g., a hybrid ad where the user clicked on ad text but not on the chat interface), or because the ad is not enabled for chat.

At state 7, after a chat connection is initiated, the agent takes the user (via the user browser) to a website associated with the advertiser (e.g., website 108). The agent can select the landing location on the website and can chose a specific location based on the interests of the user (or the landing page and/or the specific location may be automatically selected by the chat system 102). The agent can then continue to chat with the user while the user browses the website.

At state 8, information regarding the chat is saved in a database. For example, the chat database 104 can store statistical information regarding the chat session optionally including some or all of the following: where and how the chat was launched, the time from when the chat was displayed to the visitor's first interaction, the duration of the chat, the chat transcript, and/or other information discussed herein. Some or all of the stored data can be reported to an authorized recipient, who can use the information to evaluate a marketing campaign, chat effectiveness, the effectiveness of a particular agent, how long chat sessions are taking, what sites are better locations for ads, etc.

Optionally (on a web page of a website of a client of the chat service), the program code may provide a tracking mechanism, such as a chat beacon, that enables communication between a visitor's browser or other website content consuming application and the chat service provider, which, for example, can monitor the behavior of the person visiting the website 108. For example, a beacon can be provided on a web page associated with an online catalog of a merchant. The beacon can provide information, such as some or all of the following: the IP address of the computer that retrieved the beacon, the time the beacon was executed, the type of browser that retrieved the beacon, previously set cookie values, etc. In addition, a beacon/tag can be embedded in a website order confirmation page which informs the appropriate server that a purchase has been made, thereby enabling sales to be tracked and measured.

By way of example and not limitation, the beacon can be JavaScript or a small (e.g., 1×1 pixel) transparent image (or an image of the same color of the background) that is embedded in a web page (e.g., an HTML page), or implemented using an HTML iframe, style, script, input link, embed, object, and/or tags to track usage. When the user/visitor accesses the web page, the beacon is embedded in the web page. The beacon instructs the browser to connect to a server. During this connection information about the visit/visitor can be passed to the server. The server can store this information in a database and/or return instructions to the web browser based on the information and rules.

Thus, as described above, example embodiments of online interactive communication technology provide a mechanism for incorporating live chats into a display ad campaign. Optionally, live chats initiated via an ad are routed to a chat server and/or agent once it has been established that the end-user wishes to interact and/or communicate with someone via the chat user interface. Example embodiments of the chat enabled ads can be utilized with third party ad serving engines which deploy ads as part of an ad campaign. Thus, example embodiments described herein increase the usefulness and effectiveness of Internet advertising by introducing a human component to the advertising process via chat.

It should be understood that certain variations and modifications of this invention would suggest themselves to one of ordinary skill in the art. The scope of the present invention is not to be limited by the illustrations or the foregoing descriptions thereof.

What is claimed is:

1. A method of providing interactive online communication, the method comprising:
causing at least in part a chat enabled advertisement to be provided over a network to a user via a browser hosted on a user terminal, wherein the advertisement is provided to the user at least partly in response to a search query from the user, and wherein the advertisement includes information regarding a product or service and includes a chat control;
causing at least in part a connection to be made between a chat server and a chat interface associated with the advertisement, the chat interface including a text entry and display area, wherein the connection is made after the user has activated the chat control and/or taken an action that satisfies a first chat connection rule; and
at least partly enabling a human chat agent to chat at least textually with the user.

2. The method as defined in claim 1, wherein the advertisement is provided by a server controlled by a first entity, the search results are provided by a second entity, and chat service is provided by a third entity.

3. The method as defined in claim 1, wherein the advertisement includes a link to a website which can be activated by the user without initiating chat, so that activation of the link causes a resource associated with the linked-to website to be presented to the user via the browser, wherein the advertised product or service is offered for sale.

4. The method as defined in claim 1, wherein the agent causes a second web page to be displayed via the user browser without affecting the positioning of the chat interface.

5. The method as defined in claim 1, wherein the advertisement includes a movie file.

6. The method as defined in claim 1, wherein the chat interface is displayed via a frame, iframe, xframe, popup or embedded in an HTML page.

7. The method as defined in claim 1, the method further comprising storing in computer readable memory:
via which website the chat was launched; and
a transcript of the chat.

8. The method as defined in claim 1, wherein a software program provides chat text to the user via the chat interface prior to the chat agent chatting with the user.

9. A method of providing interactive online communication, the method comprising:
causing at least in part an advertisement to be provided over a network to a user via a browser hosted on a user terminal, wherein the advertisement includes a chat interface, and wherein the advertisement includes information regarding a product or service and includes a chat control;
causing at least in part a connection to be made between a chat server and the chat interface associated with the advertisement, the chat interface including a text entry and display area; and
at least partly to the occurrence of a first condition, enabling a human chat agent to chat at least textually with the user via the advertisement chat interface.

10. The method as defined in claim 9, wherein the chat connection is initiated in response to the user clicking on a portion of the advertisement.

11. The method as defined in claim 9, wherein the chat connection is initiated in response to the user entering text via the chat interface.

12. The method as defined in claim 9, wherein the chat connection is initiated when the advertisement is displayed.

13. The method as defined in claim 9, wherein the advertisement is provided by a server controlled by a first entity and chat service is provided by a third entity.

14. The method as defined in claim 9, wherein the advertisement includes a link to a website which can be activated by the user without initiating chat, so that activation of the link causes a resource associated with the linked-to website to be presented to the user via the browser, wherein an advertised product or service is offered for sale.

15. The method as defined in claim 9, wherein the agent causes a second web page to be displayed via the user browser without affecting the positioning of the chat interface.

16. The method as defined in claim 9, wherein the advertisement includes a movie file.

17. The method as defined in claim 9, wherein the chat interface is displayed via a frame, iframe, xframe, popup or embedded in an HTML page.

18. The method as defined in claim 9, the method further comprising storing in computer readable memory:
via which website the chat was launched; and
a transcript of the chat.

19. The method as defined in claim 9, wherein a software program provides chat text to the user via the chat interface prior to the chat agent chatting with the user.

20. A system configured to provide interactive online communication, the system comprising:
a first data store that stores a chat enabled advertisement;
a first computer system coupled to the first data store, the first computer system configured to serve the chat enabled advertisement; and
a chat system configured to conduct an online chat via the chat enabled advertisement.

21. The system as defined in claim 20, wherein the chat enabled advertisement includes a user accessible chat initiation control.

22. The system as defined in claim 20, wherein the chat enabled advertisement is configured to initiate a chat connection with the chat system in response to the user entering text via a text input field.

23. The system as defined in claim 20, wherein the chat enabled advertisement is configured to initiate a chat connection when the advertisement is displayed.

24. The system as defined in claim 20, wherein the advertisement includes a link to a website which can be activated by the user without initiating chat, so that activation of the link causes a resource associated with the linked-to website to be presented to the user via the browser, wherein an advertised product or service is offered for sale.

25. The system as defined in claim 20, wherein the chat system is configured to enable an agent to cause different web pages to be presented to the user while a chat interface is displayed to the user.

26. The system as defined in claim 20, wherein the advertisement includes a movie file.

27. The system as defined in claim 20, wherein the advertisement includes a chat interface configured to be displayed via a frame, iframe, xframe, popup or embedded in an HTML page.

28. The system as defined in claim 20, the system further comprising a data store for storing:
via which website at least one chat was launched; and
a transcript of the at least one chat.

29. The system as defined in claim 20, further comprising programmatic code configured to cause at least in part pre-stored chat text via a text field provided via the advertisement.

30. A method of providing interactive online communication, the method comprising:
causing at least in part an advertisement for a first item to be provided over a network to a user via a browser hosted on a user terminal;
if a first condition is met, at least partly causing the advertisement to be displayed via the browser with an associated chat interface; and
if a first condition is not met, at least partly causing the advertisement to be displayed via the browser without an associated chat interface.

31. The method as defined in claim 31, wherein the first condition relates to availability of a human agent to chat with the user.

32. The method as defined in claim 31, wherein a connection with a chat server is initiated at least partly in response to the user clicking on a portion of the advertisement.

33. The method as defined in claim 31, wherein a connection with a chat server is initiated at least partly in response to the user entering text via the chat interface.

34. The method as defined in claim 31, wherein the advertisement is provided by a server controlled by a first entity and chat service is provided by a third entity.

35. The method as defined in claim 31, wherein a human agent causes the browser to navigate from a first web page to a second web page without affecting the positioning of the chat interface.
